(19) United States
(12) Patent Application Publication
(10) Pub. No.: US 2008/0177831 A1
(43) Pub. Date: Jul. 24, 2008

(54) Communitized media application and sharing apparatus

(75) Inventor: Meng-Gung Li, Sijhih City (TW)

Correspondence Address: BIRCH STEWART KOLASCH & BIRCH, PO BOX 747, FALLS CHURCH, VA, 22040-0747, US

(73) Assignee: KAT DIGITAL CORP.

(21) Appl. No.: 11/808,743

(22) Filed: Jun. 12, 2007

(30) Foreign Application Priority Data
Jan. 19, 2007 (TW) 096102018

(51) Int. Cl. G06F 3/00

(52) U.S. Cl. 709/204

(57) ABSTRACT

The present invention provides a communitized media application and sharing apparatus. In particular, the communitized media application and sharing apparatus of the invention is able to upload or download the media contents, which belong to a specific community, by using technologies such as RSS.

### BACKGROUND OF THE INVENTION

1. Field of the Invention

The invention relates to a communitized media application and sharing apparatus. In particular, the invention relates to the communitized media application and sharing apparatus which are able to upload or download the multimedia contents which belong to a specific community by using technologies such as RSS.

2. Description of the Prior Art

Several information-technology companies and consumer electronics companies have been developing Digital Home related applications actively. The core of Digital Home is to link all information, communication, or consumer electronic products together to form a Home Networking Structure by cable or wireless networking technology. Furthermore, Home networking also integrates external network system to accomplish e-intellectual future life prospects such as home energy management, home security, home care, remote appliance repairing, and digital interactive television through specific Home Gateway.

Newly developed digital home appliances, such as AV products with networking function, like STB, portable media player, DVD, AV digital media center, game console, MP3 player . . . , and etc are starting to compete in the market. By these Digital Home apparatuses, users will be able to receive digital media contents anywhere in the house, including living room, kitchen, bedroom . . . etc.

Information feed which is one type of data processing has become increasingly popular. Information feeds usually can be generally described as technology for providing regularly updated interested data items (e.g., news) to an electronic device. Technologies such as RSS and ATOM allow users to subscribe to information feeds available over the Internet. Once subscribed, the user can see a collection of data items available on the particular feed. The data items typically include a title and a short description. The data items may also provide links to a World Wide Web page or other resources that the user may access to more detailed information about the subject of the data item.

However, with the coming of the age of Web 2.0, there is no media player apparatus which has been developed for specific communities although technologies such as RSS and Atom have added the concept of sharing. If each member in a specific community can provide, edit, and share media contents which only belong to the specific community, the feature of the community will be enhanced to attract more members that have the same hobby to join the community, thus bringing in more media contents to be shared. By this way, the spirit of Web 2.0 can be fully embodied, and the personalized and diverse service requirements will be satisfied.

Accordingly, a scope of the invention is to provide a communitized media application and sharing apparatus for uploading or downloading media contents which belong to a specific community by using technologies such as RSS. Furthermore, the communitized media application and sharing apparatus, according to the invention, can also transmit media contents to be played on media players such as AV appliances, STB, DVR, PMP, or smart phones using a particular protocol through Home Network, like Intranet.

### SUMMARY OF THE INVENTION

The communitized media application and sharing apparatus, according to a preferred embodiment of the invention, includes a first communication module, a processing module, a user interface module, and a media playing module. The first communication module is capable of linking to a server through a network. The server includes a first storage module which relates to a community and therein stores a plurality of first media contents uploaded by at least one granted party. The processing module, coupled to the first communication module, is for transmitting a first request information, which includes an identification (ID) of the community, through the first communication module over the network to the server. The server receives the first request information, and then it generates, based on the ID, a list of one or more hits, ; the list of one more hits is transmitted to the first communication module over the network, and each of the hits refers to one of the first media contents which each has an associated syndication feed. The user interface module, coupled to the processing module, is controlled by the processing module for executing a browsing application to display the list of one or more hits received by the first communication module and for receiving a selection for the hits, wherein the processing module downloads one or more of the first media contents stored in the first storage module in response to the selection. The media playing module, coupled to the processing, is controlled by the processing module for playing the downloaded first media contents.

The advantage and spirit of the invention may be understood by the following recitations together with the appended drawings.

### BRIEF DESCRIPTION OF THE APPENDED DRAWINGS

FIG. 1 is a schematic diagram illustrating the communitized media application and sharing apparatus and their links to the server according to a preferred embodiment of the invention.

FIG. 2 is a schematic diagram illustrating the appearance of the communitized media application and sharing apparatus.

### DETAILED DESCRIPTION OF THE INVENTION

The scope of the invention is to provide a communitized media application and sharing apparatus. In particular, the communitized media application and sharing apparatus upload or download media contents which belong to a specific community by using technologies such as RSS. Moreover, the communitized media application and sharing apparatus, according to the invention, can also transmit media contents to be played on other media players with a particular protocol.

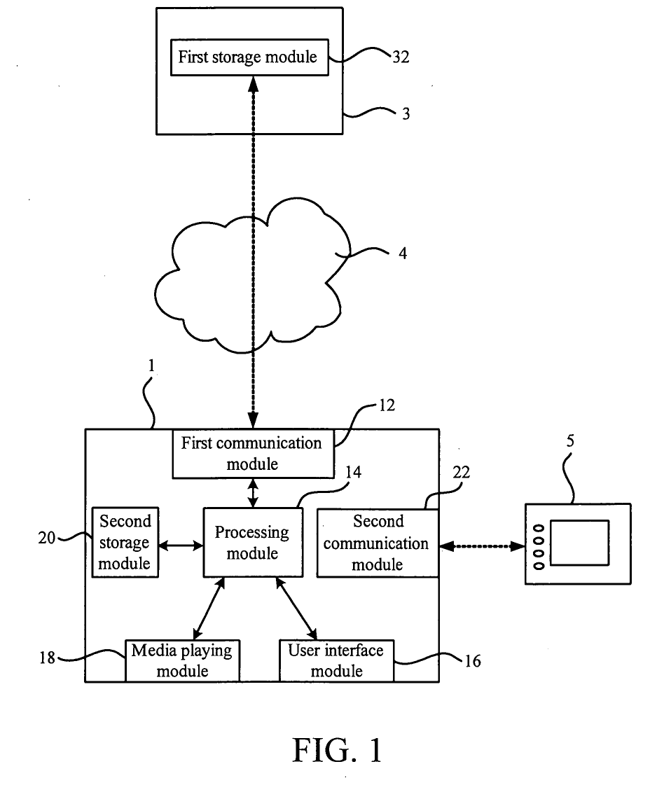

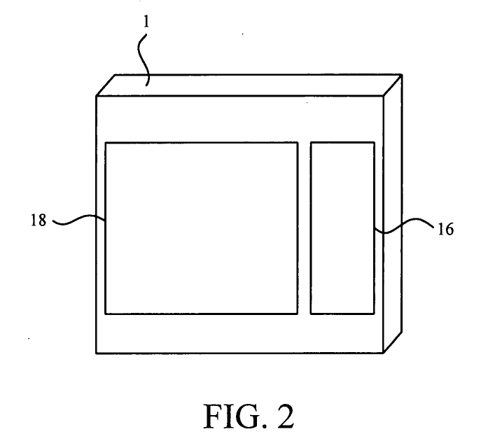

Referring to FIG. 1 and FIG. 2, FIG. 1 is a schematic diagram illustrating the communitized media application and sharing apparatus 1 and their links to the server 3 according to a preferred embodiment of the invention, and FIG. 2 is a schematic diagram illustrating the appearance of the communitized media application and sharing apparatus 1. As shown in FIG. 1, the communitized media application and sharing apparatus 1 include a first communication module 12, a processing module 14, a user interface module 16, and a media playing module 18.

As shown in FIG. 1, the first communication module 12 is capable of linking to a server 3 through a network 4. The server 3 includes a first storage module 32 which relates to a community, and therein stores a plurality of first media contents uploaded by at least one granted party.

The processing module 14, coupled to the first communication module 12, is for transmitting a first request information, which includes an identification (ID) of the community, through the first communication module 12 over the network 4 to the server 3. The server 3 receives the first request information, and then it generates, based on the ID, a list of one or more hits; the list of one more hits is transmitted to the first communication module 12 over the network 4, and each of the hits refers to one of the first media contents which each has an associated syndication feed.

The user interface module 16, coupled to the processing module 14, is controlled by the processing module 14 for executing a browsing application to display the list of one or more hits received by the first communication module 12 and for receiving a selection for the hits. The processing module 14 downloads one or more of the first media contents stored in the first storage module 32 in response to the selection.

The media playing module 18, coupled to the processing, is controlled by the processing module 14 for playing the downloaded first media contents.

In an embodiment, the communitized media application and sharing apparatus 1 further includes a second storage module 20. The second storage module 20, coupled to the processing module 14, is controlled by the processing module 14 to store the downloaded first media contents.

Furthermore, in the embodiment, the second storage module 20 therein also stores at least one second media content. The user interface module 16 is capable of receiving a second request information. The processing module 14 uploads, in response to the second request information, one or more of the at least one second media content to the first storage module 32 of the server 3 through the first communication module 12 over the network 4.

In an embodiment, each of the syndication feeds is an RSS feed.

In an embodiment, each of the syndication feeds is an ATOM feed.

In an embodiment, the browsing application is an XML-based browsing application.

As shown in FIG. 1, in an embodiment, the communitized media application and sharing apparatus 1, according to the invention, further includes a second communication module 22 which is coupled to the processing module 14. The processing module 14 is capable of transmitting the downloaded first media contents through the second communication module 22 by a transmission protocol to a subscribed media playing apparatus 5. For instance, the communitized media application and sharing apparatus 1, according to the invention, can also transmit media contents to be played on the media players such as AV appliances, STB, DVR, PMP, or smart phone in a particular protocol through Home Network, like Intranet.

Furthermore, in the embodiment, the transmission protocol can be a power line communication protocol, an Ethernet protocol, a Bluetooth protocol, a Wi-Fi protocol, or a Wi-Max protocol.

In an embodiment, the network 4 is an Intranet or an Internet.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A communitized media application and sharing apparatus, comprising:
a first communication module capable of linking to a server through a network, the server comprising a first storage module relating to a community and therein storing a plurality of first media contents uploaded by at least one granted party;
a processing module, coupled to the first communication module, for transmitting a first request information comprising an identification (ID) of the community through the first communication module over the network to the server, wherein the server receives the first request information, and it generates, based on the ID, a list of one or more hits, the list of one more hits is transmitted to the first communication module over the network, and each of the hits refers to one of the first media contents which each has an associated syndication feed;
a user interface module, coupled to the processing module and controlled by the processing module, for executing a browsing application to display the list of one or more hits received by the first communication module, and for receiving a selection for the hits, wherein the processing module downloads one or more of the first media contents stored in the first storage module in response to the selection; and
a media playing module, coupled to the processing and controlled by the processing module, for playing the downloaded first media contents.

2. The communitized media application and sharing apparatus of claim 1, further comprising a second storage module, coupled to the processing module and controlled by the processing module, for storing the downloaded first media contents.

3. The communitized media application and sharing apparatus of claim 2, wherein the second storage module therein also stores at least one second media content, the user interface module is capable of receiving a second request information, the processing module uploads, in response to the second request information, one or more of the at least one second media content to the first storage module of the server through the first communication module over the network.

4. The communitized media application and sharing apparatus of claim 1, wherein each of the syndication feeds is an RSS feed.

5. The communitized media application and sharing apparatus of claim 1, wherein each of the syndication feeds is an ATOM feed.

6. The communitized media application and sharing apparatus of claim 1, wherein the browsing application is an XML-based browsing application.

7. The communitized media application and sharing apparatus of claim 1, further comprising a second communication module, coupled to the processing module, the processing module is capable of transmitting the downloaded first media contents through the second communication module in a transmission protocol to a subscribed media playing apparatus.

8. The communitized media application and sharing apparatus of claim 7, wherein the transmission protocol is one selected from the group consisting of a power line communication protocol, an Ethernet protocol, a Wi-Fi protocol, and a Wi-Max protocol.

9. The communitized media application and sharing apparatus of claim 1, wherein the network is an Intranet or an Internet.
